(19) United States
(12) Patent Application Publication
(10) Pub. No.: US 2021/0281057 A1
(43) Pub. Date: Sep. 9, 2021

(54) Modular Light Switch and Electric Receptacle Faceplate System

(71) Applicant: Snap Fit LLC, Mount Pleasant, SC (US)

(72) Inventors: Tyler M Neill, Canton, GA (US); Ian Bowers, Mount Pleasant, SC (US)

(21) Appl. No.: 17/195,490

(22) Filed: Mar. 8, 2021

Related U.S. Application Data
(60) Provisional application No. 62/986,289, filed on Mar. 6, 2020.

(51) Int. Cl. H02G 3/14

(52) U.S. Cl. CPC H02G 3/14; F21V 23/0464

(57) ABSTRACT

A modular light switch and electric receptacle faceplate system is a system that enables users to create a custom faceplate that accommodates any combination of switches or outlets in a single-gang configuration or a multiple-gang configuration. The system may include a surrounding frame and at least one interchangeable faceplate assembly. The surrounding frame enables the quick assembling of the custom faceplate by receiving the at least one interchangeable faceplate assembly. The at least one interchangeable faceplate assembly is a faceplate assembly that can accommodate different types of electrical devices such as switches or outlets. The at least one interchangeable faceplate assembly can be easily fastened to the surrounding frame to form the custom faceplate. In addition, the at least one interchangeable faceplate assembly can be combined with other interchangeable faceplate assemblies on the surrounding frame to form a custom faceplate that accommodates multiple switches, outlets, or any combination thereof.

The current application claims a priority to the U.S. provisional patent application Ser. No. 62/986,289 filed on Mar. 6, 2020. The current application is filed on Mar. 8, 2021 while Mar. 6, 2021 was on a weekend.

### FIELD OF THE INVENTION

The present invention relates generally to faceplates for switches and electrical outlets, such as those used in residential and commercial buildings. More specifically, the present invention is a faceplate system with interchangeable faceplates designed for different switch and electrical outlet combinations.

### BACKGROUND OF THE INVENTION

Electrical circuit devices such as switches and electrical outlets for receiving standard electrical plugs are usually mounted within wall boxes such that only a small portion of the electrical circuit device protrudes outward from the surface of the wall. Further, wiring connecting the electrical devices to sources of power, ceiling lights, or other remotely situated electrical equipment is generally positioned within the wall and coupled to the electrical devices situated within the box. Finally, faceplates are provided to enclose the switches and electrical outlets, thereby preventing inadvertent access to the electrically conductive elements of the switches and outlets, hiding the unattractive wiring and the rest of the electrical components.

However, several drawbacks are associated with existing faceplates for multi-gang electrical wall boxes. While there are several types of faceplates, each faceplate is often designed to accommodate a specific type of switch or outlet. Further, to install or service a random electrical device, an electrician must carry several types of wall electrical outlets faceplates to each site, necessitating the ordering and inventorying of different types of faceplates beforehand. Moreover, there is a limitless number of potential combinations of toggle, decora, dimmer, and knob switches, each of which requires a faceplate that matches said combination. This means that the electrician also must carry different types of faceplates to accommodate standard combinations. While some modular faceplates do exist, the design requires left, right, and center pieces which means that the current modular system requires an electrician to carry different faceplates and fasteners (i.e., left side faceplates, right side faceplates, and middle faceplates). The need to carry different tools and parts is time-consuming, cumbersome, expensive, and inefficient. Furthermore, some combinations of switches and outlets in a multi-gang receptacle do not have a readily available one-piece faceplate and require a custom solution. The present invention aims to solve some of these problems by disclosing a modular light switch and electric receptacle faceplate system by utilizing a frame and standardized insert system—rather than left, right, and center pieces.

### SUMMARY OF THE INVENTION

The present invention is a modular light switch and electric receptacle faceplate system designed to accommodate different switches or outlets in a single-gang configuration or a multiple-gang configuration. The present invention is simple in structure, inexpensive to manufacture, and easy to use. The present invention is a universal kit that enables users to make any combination of switches and/or outlets without being limited by the design or position of the switch or the outlet on the wall box. The present invention includes a system with multiple modular faceplates designed to fit different outlets/switches, reducing the number of parts the user must carry around to install or service an electrical device. The present invention can accommodate a single switch/outlet or multiple switches/outlets in a single assembly. Further, the modular faceplates of the present invention can be readily installed using a snap-fit fastening mechanism which facilitates the installation and servicing of the different electrical devices and wiring and can accommodate replacement or remodeling for future servicing. Additional features and benefits of the present invention are discussed in the sections below.

### BRIEF DESCRIPTION OF THE DRAWINGS

FIG. 1 is a front perspective view showing the present invention, wherein the present invention is shown in a three-gang configuration to accommodate two classic toggle switches on the right and left and one decora switch in the center.

FIG. 2 is a rear perspective view showing the present invention, wherein the present invention is shown in the three-gang configuration to accommodate two classic toggle switches on the right and left and one decora switch in the center.

FIG. 3 is a front exploded perspective view showing the present invention, wherein the present invention is shown in the three-gang configuration.

FIG. 4 is a rear exploded perspective view showing the present invention, wherein the present invention is shown in the three-gang configuration.

FIG. 5 is a front perspective view showing the at least one interchangeable faceplate assembly.

FIG. 6 is a rear perspective view showing the at least one interchangeable faceplate assembly.

FIG. 7 is a front view showing the present invention, wherein the present invention is shown in a single-gang configuration.

FIG. 8 is a front view showing the present invention, wherein the present invention is shown in a five-gang configuration to accommodate (from left to right) one traditional toggle switch, two decora switches, one traditional toggle switch, and one electrical outlet.

### DETAILED DESCRIPTION OF THE INVENTION

All illustrations of the drawings are for the purpose of describing selected versions of the present invention and are not intended to limit the scope of the present invention.

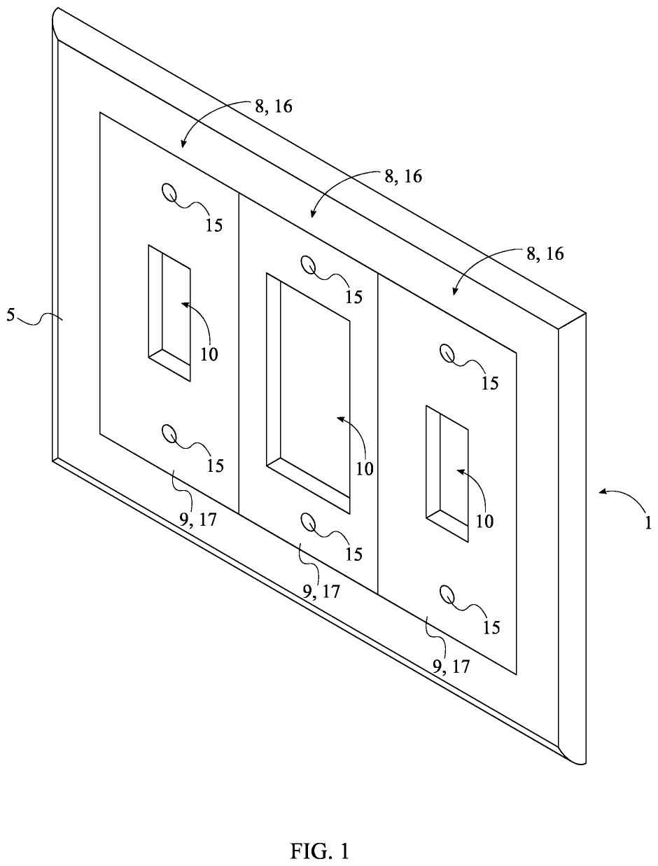

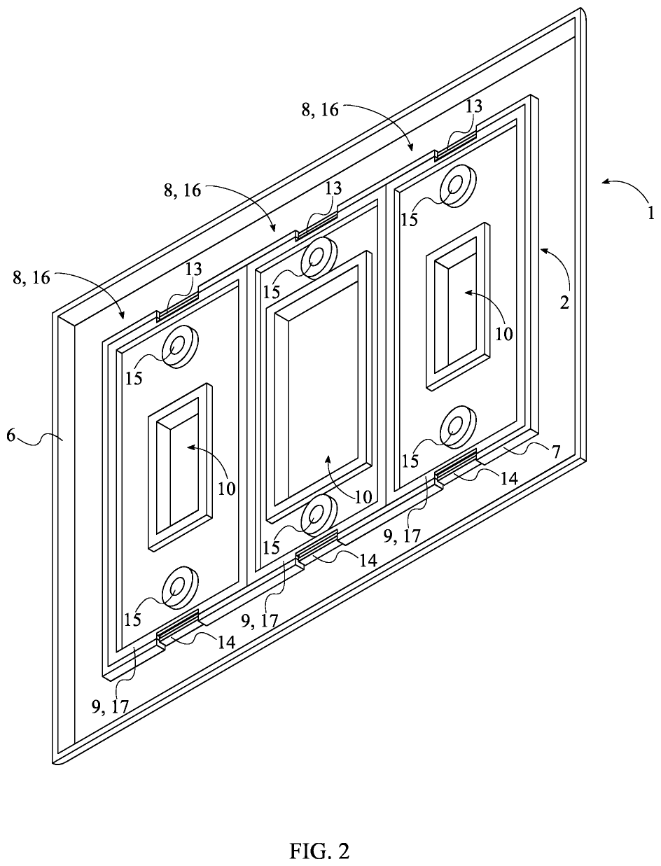

The present invention is a modular light switch and electric receptacle faceplate system that enables users to create a custom faceplate that accommodates any combination of switches or outlets in a multiple-gang configuration. Single-gang configurations of the present invention are also available so that all the user's faceplates within a room can match each other. As can be seen in FIGS. 1 and 2, the present invention may comprise a surrounding frame 1 and at least one interchangeable faceplate assembly 8. The surrounding frame 1 enables the quick assembling of the custom faceplate by receiving the at least one interchangeable faceplate assembly 8. The at least one interchangeable faceplate assembly 8 is at least one easy-to-change faceplate that accommodates different types of electrical devices such as traditional toggle switches, decora switches, dimmer switches, dimmer knobs, or outlets. In addition, the at least one interchangeable faceplate assembly 8 can be combined with other interchangeable faceplate assemblies to form a custom faceplate that accommodates multiple switches, outlets, or any combination thereof.

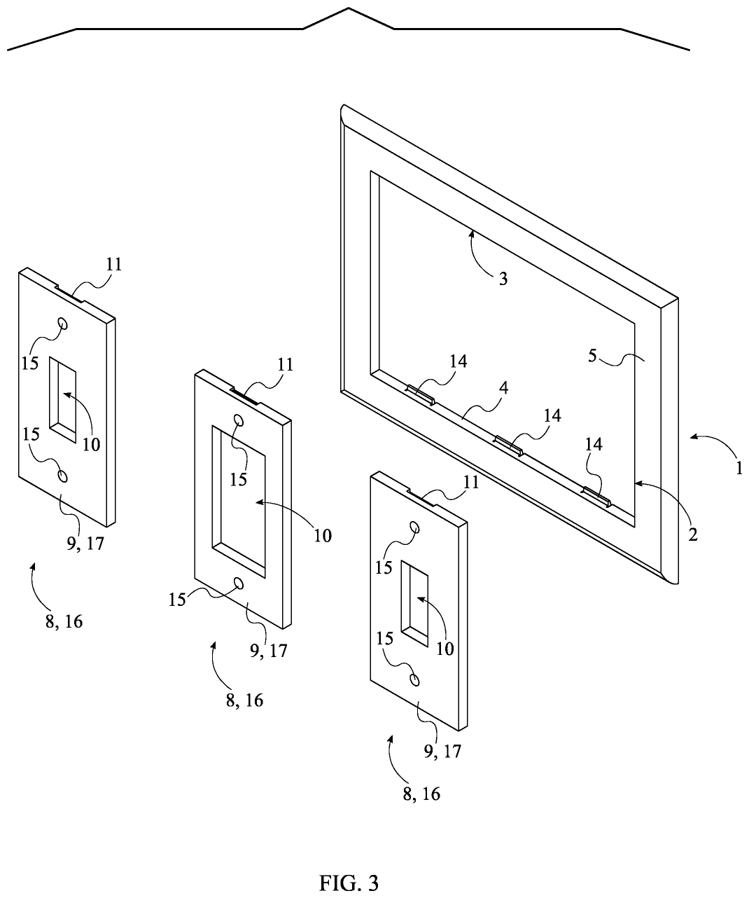

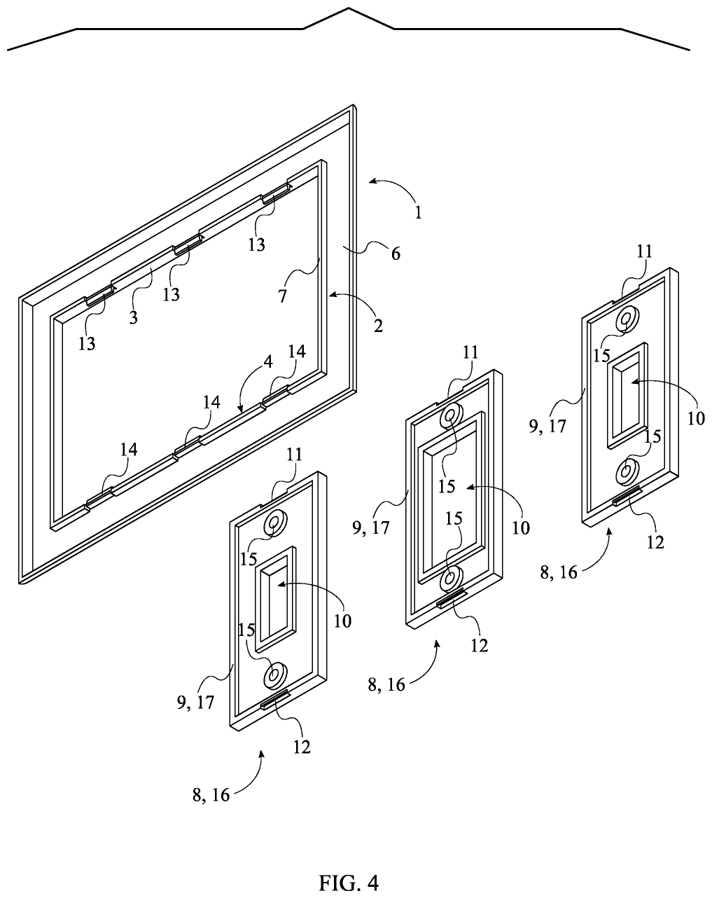

The general configuration of the aforementioned components enables users to install or service custom faceplates without the need of purchasing multiple faceplates to accommodate different combinations of switches and/or outlets. As can be seen in FIGS. 3 and 4, the surrounding frame 1 comprises an inner frame rim 2 to accommodate the desired at least one interchangeable faceplate assembly 8 to form a custom faceplate. In addition, the at least one interchangeable faceplate assembly 8 comprises a plate body 9, at least one interface opening 10, a first inner snap feature 11, a first outer snap feature 13, a second inner snap feature 12, and a second outer snap feature 14. The plate body 9 is designed to cover the wiring and other electrical components positioned within the wall box while the at least one interface opening 10 enables the corresponding switch or outlet to protrude out of the wall box through the plate body 9. For example, the plate body 9 may have a rectangular design to cover a rectangular wall box with a square at least one interface opening 10 that accommodates a toggle switch. However, the plate body 9 may also have different designs that cover non-traditional wall boxes. The first inner snap feature 11 and the first outer snap feature 13 enable the quick and easy fastening of the plate body 9 to a portion of the inner frame rim 2. Likewise, the second inner snap feature 12 and the second outer snap feature 14 enable the quick and easy fastening of the plate body 9 to another portion of the inner frame rim 2, thus fully securing the plate body 9 to the surrounding frame 1.

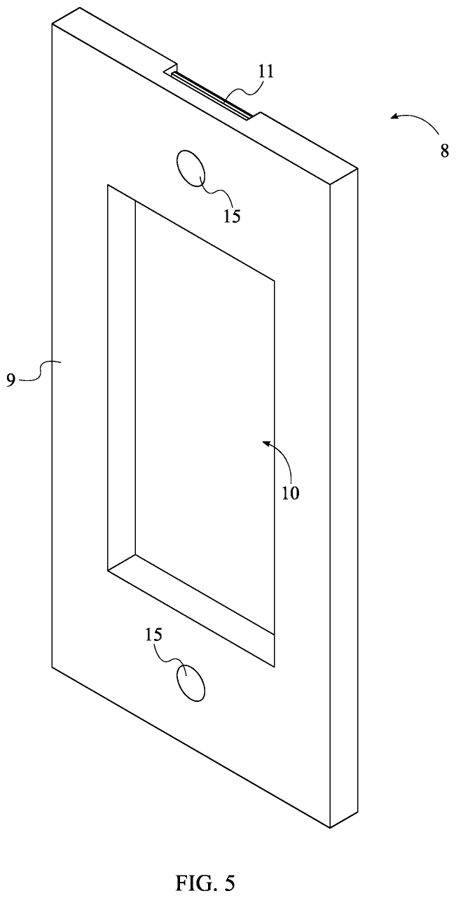

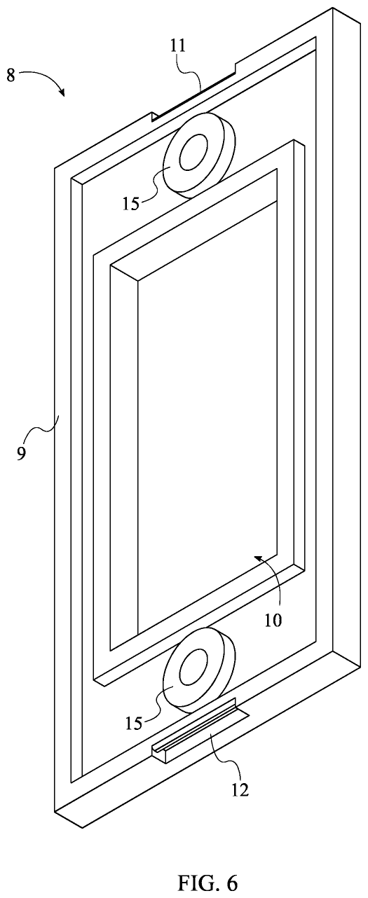

As can be seen in FIGS. 5 and 6, the at least one interface opening 10 traverses normal through the plate body 9 to enable the at least one interface opening 10 to receive and hold in place the corresponding switch and/or outlet. The first inner snap feature 11 is peripherally integrated into the plate body 9. Similarly, the second inner snap feature 12 is peripherally integrated into the plate body 9, with the second inner snap feature 12 positioned opposite to the first inner snap feature 11. In addition, the first inner snap feature 11 and the second inner snap feature 12 are preferably positioned along the vertical centroidal axis of the plate body 9. This positioning of the first inner snap feature 11 and the second inner snap feature 12 enable the plate body 9 to be fully secured to the surrounding frame 1 without requiring the plate body 9 to be secured to the surrounding frame 1 in a specific horizontal orientation. Moreover, as can be seen in FIGS. 3 and 4, the first outer snap feature 13 and the second outer snap feature 14 are mounted onto the inner frame rim 2 to receive the first inner snap feature 11 and the second inner snap feature 12, respectively. The first outer snap feature 13 and the second outer snap feature 14 are also positioned opposite to each other about the inner frame rim 2 with a similar arrangement as the first inner snap feature 11 and the second inner snap feature 12 so that when the plate body 9 is being fastened to the inner frame rim 2, the corresponding snap features easily engage with each other. When the desired at least one interchangeable faceplate assembly 8 is fastened to the surrounding frame 1, the corresponding plate body 9 is positioned within the inner frame rim 2. In addition, the first inner snap feature 11 and the first outer snap feature 13 are engaged to each other, while the second inner snap feature 12 and the second outer snap feature 14 are engaged to each other. Thus, the plate body 9 is securely fastened to the surrounding frame 1. To remove the plate body 9 from the surrounding frame 1, the user securely grabs onto the plate body 9 and pulls the plate body 9 with enough strength that the first outer snap feature 13 and the second outer snap feature 14 release the first inner snap feature 11 and the second outer snap feature 14, respectively.

Furthermore, the first inner snap feature 11, the second inner snap feature 12, the first outer snap feature 13, and the second outer snap feature 14 preferably correspond to the fastening components of a snap-fit fastener. As can be seen in FIGS. 3 and 4, the first inner snap feature 11 and the second inner snap feature 12 may each be the female piece of a snap-fit fastener, while the first outer snap feature 13 and the second outer snap feature 14 may each be the male piece of the snap-fit fastener. For example, the first inner snap feature 11 and the second inner snap feature 12 can each be the hook-receiving slot of a cantilever snap-fit fastener, and the first outer snap feature 13 and the second outer snap feature 14 can each be the hook of the cantilever snap-fit fastener. In other embodiments, the first inner snap feature 11 and the second inner snap feature 12 can be female pieces of different fasteners while the first outer snap feature 13 and the second outer snap feature 14 are the corresponding male pieces.

The surrounding frame 1 is designed to fully cover any remaining exposed space on the perimeter of the wall box not being covered by the plate body 9. As can be seen in FIGS. 3 and 4, the surrounding frame 1 may further comprise a first frame face 5, a second frame face 6, and an inner frame ledge 7. The first frame face 5 and the second frame face 6 preferably correspond to the outer face and the inner face of the surrounding frame 1, respectively. The first frame face 5 and the second frame face 6 are positioned opposite to each other about the surrounding frame 1 due to the thin flat structure of the surrounding frame 1. The inner frame ledge 7 enables the plate body 9 to be flushed with the surrounding frame 1. The inner frame ledge 7 is connected onto the second frame face 6 so that the plate body 9 is flushed with the first frame face 5. The inner frame ledge 7 is also positioned around the inner frame rim 2 so that the plate body 9 is fixed within the inner frame rim 2. Further, the first outer snap feature 13 and the second outer snap feature 14 are integrated into the inner frame rim 2 so that the snap features are hidden from view when the plate body 9 is fastened to the surrounding frame 1. In other embodiments, the surrounding frame 1 can have different ornamental designs with non-flat configurations.

To secure the present invention to the corresponding wall box or electrical device, the at least one interchangeable faceplate assembly 8 may further comprise a plurality of fastener-receiving holes 15. As can be seen in FIGS. 5 and 6, the plurality of fastener-receiving holes 15 enable the user to secure the plate body 9 to the electrical device or the wall box utilizing fasteners such as screws, thus securing the whole assembly to the wall box or the electrical device. The plurality of fastener-receiving holes 15 traverses normal through the plate body 9 to maintain the plate body 9 parallel to the wall. The plurality of fastener-receiving holes 15 is also distributed across the plate body 9 so that the whole plate body 9 is fixed to the wall box or electrical device. Further, the plurality of fastener-receiving holes 15 is positioned about the plate opening to reduce stress points on the plate body 9 that may cause the plate body 9 to crack if too much force is applied when fastening the plate body 9. In alternate embodiments, the plurality of fastener-receiving holes 15 can be replaced with other means of fastening the plate body 9 to the wall body or electrical device.

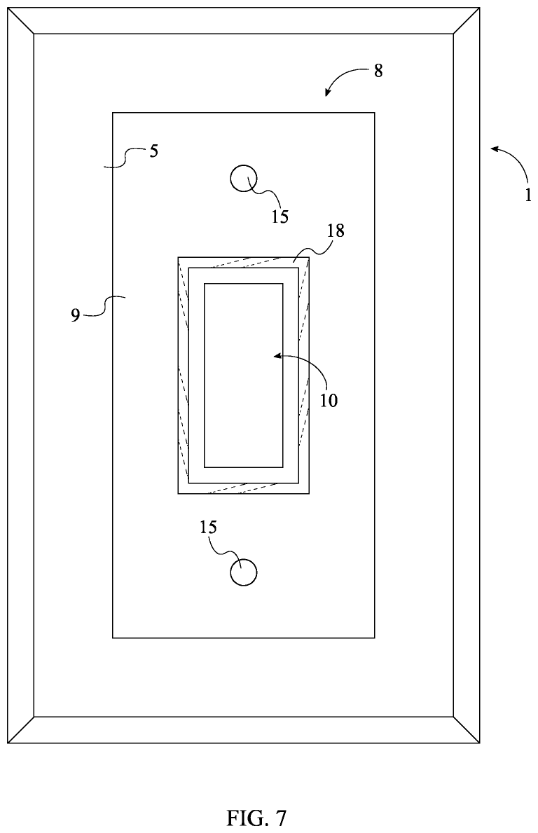

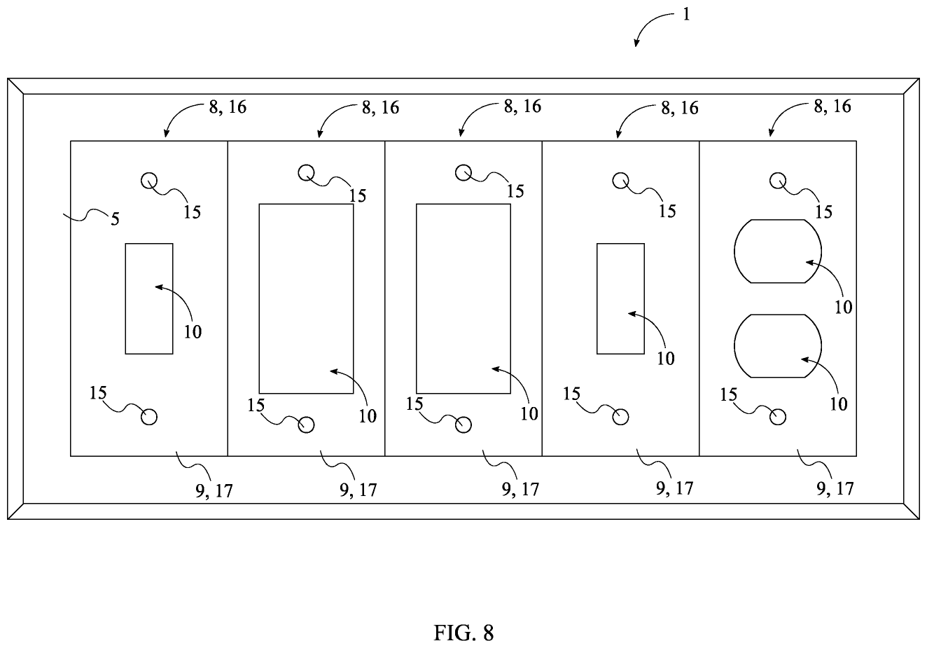

As previously mentioned, the present invention can be configured into a single-gang configuration or a multiple-gang configuration. In the single-gang configuration, the surrounding frame 1 and the inner frame rim 2 are designed to accommodate a single interchangeable faceplate assembly, as can be seen in FIG. 7. On the other hand, in a multiple-gang configuration, the surrounding frame 1 and the inner frame rim 2 are designed to accommodate multiple single interchangeable faceplate assemblies in a two-gang, three-gang, four-gang, or five-gang configuration, as can be seen in FIGS. 1 and 8. The at least one interchangeable faceplate assembly 8 may be a plurality of interchangeable faceplate assemblies 16 that can accommodate multiple electrical devices including, but not limited to, switches, outlets, or any combination thereof. Consequently, the plate body 9 for each of the plurality of interchangeable faceplate assemblies 16 is a plurality of plate bodies 17. The plurality of plate bodies 17 is serially positioned with the inner frame rim 2 to accommodate the desired number of plate bodies. In addition, the plurality of plate bodies 17 is coextensive with the inner frame rim 2 to fully cover the space within the inner frame rim 2.

As can be seen in FIGS. 3 and 4, to accommodate the plurality of plate bodies 17, the inner frame rim 2 may comprise a first lengthwise section 3 and a second lengthwise section 4 preferably corresponding to the longer inner edges of the inner frame rim 2. The first lengthwise section 3 and the second lengthwise section 4 are positioned parallel and opposite to each other about the inner frame rim 2. The first outer snap feature 13 for each of the plurality of interchangeable faceplate assemblies 16 is positioned along the first lengthwise section 3 which may correspond to the upper lengthwise section of the inner frame rim 2. Moreover, the second outer snap feature 14 for each of the plurality of interchangeable faceplate assemblies 16 is positioned along the second lengthwise section 4 which may correspond to the lower lengthwise section of the inner frame rim 2. Thus, each plate body 9 of the plurality of plate bodies 17 can be attached or detached from the inner frame rim 2 without worrying about the position on which the plate body 9 is placed.

Each plate body 9 and at least one interface opening 10 of the at least one interchangeable faceplate assembly 8 can be designed to accommodate a different electrical device. As can be seen in FIG. 7, the at least one interface opening 10 may be centrally positioned on the plate body 9, but the at least one interface opening 10 may also be positioned off center to accommodate different designs of the plate body 9 matching non-traditional designs of electrical devices. Further, the at least one interface opening 10 can be configured to receive different electrical devices, as can be seen in FIG. 8. For example, the at least one interface opening 10 may be configured to receive a toggle switch. The at least one interface opening 10 may also be configured to receive a rocker switch. In addition, the at least one interface opening 10 may be configured to receive an outlet opening. Alternatively, the at least one interface opening 10 may be configured to receive other types of switches and outlets, such as light sensors, dimmers, smart plugs, Universal Serial Bus (USB) ports, etc. Furthermore, the at least one interface opening 10 may be a plurality of interface openings distributed about the plate body 9 to accommodate multiple switches, outlets, or any combination thereof in the same plate body 9. For example, the plurality of interface openings can accommodate a switch and an outlet, a switch and multiple USB ports, multiple switches, or multiple outlets. In other embodiments, the at least one interface opening 10 or the plurality of interface openings may accommodate other electrical devices.

In addition to accommodating switches and outlets, the present invention may include other features that increase the functionality of the at least one interchangeable faceplate assembly 8. As can be seen in FIG. 18, the present invention may comprise at least one night-light 18 that enables the user to locate the switch or the outlet at night or during low light conditions. The at least one night-light 18 is integrated into the plate body 9 and positioned adjacent to the at least one interface opening 10 so that the at least one night-light 18 illuminates the switch or the outlet protruding through the at least one interface opening 10. The at least one night-light 18 may be activated simultaneously when the switch or the outlet is engaged or may operate at a set schedule using a timer. Alternatively, the at least one night-light 18 may be equipped with a light sensor that activates the at least one night-light 18 when dark. In other embodiments, the present invention may be equipped with other features.

Although the invention has been explained in relation to its preferred embodiment, it is to be understood that many other possible modifications and variations can be made without departing from the spirit and scope of the invention as hereinafter claimed.

What is claimed is:

1. A modular light switch and electric receptacle faceplate system comprising:
a surrounding frame;
at least one interchangeable faceplate assembly;
the surrounding frame comprising an inner frame rim;
the at least one interchangeable faceplate assembly comprising a plate body, at least one interface opening, a first inner snap feature, a first outer snap feature, a second inner snap feature, and a second outer snap feature;
the at least one interface opening traversing normal through the plate body;
the first inner snap feature being peripherally integrated into the plate body;
the second inner snap feature being peripherally integrated into the plate body, opposite to the first inner snap feature;
the first outer snap feature and the second outer snap feature being mounted onto the inner frame rim;
the first outer snap feature and the second outer snap feature being positioned opposite to each other about the inner frame rim;
the plate body being positioned within the inner frame rim;
the first inner snap feature and the first outer snap feature being engaged to each other; and,
the second inner snap feature and the second outer snap feature being engaged to each other.

2. The modular light switch and electric receptacle faceplate system as claimed in claim 1, wherein the first inner snap feature is a female piece of a snap-fit fastener, and wherein the first outer snap feature is a male piece of the snap-fit fastener.

3. The modular light switch and electric receptacle faceplate system as claimed in claim 1, wherein the second inner snap feature is a female piece of a snap-fit fastener, and wherein the second outer snap feature is a male piece of the snap-fit fastener.

4. The modular light switch and electric receptacle faceplate system as claimed in claim 1 comprising:
the surrounding frame further comprising a first frame face, a second frame face, and an inner frame ledge;
the first frame face and the second frame face being positioned opposite to each other about the surrounding frame;
the inner frame ledge being connected onto the second frame face;
the inner frame ledge being positioned around the inner frame rim; and,
the first outer snap feature and the second outer snap feature being integrated into the inner frame rim.

5. The modular light switch and electric receptacle faceplate system as claimed in claim 1 comprising:
the at least one interchangeable faceplate assembly further comprising a plurality of fastener-receiving holes;
the plurality of fastener-receiving holes traversing normal through the plate body;
the plurality of fastener-receiving holes being distributed across the plate body; and,
the plurality of fastener-receiving holes being positioned about the plate opening.

6. The modular light switch and electric receptacle faceplate system as claimed in claim 1 comprising:
the at least one interchangeable faceplate assembly being a plurality of interchangeable faceplate assemblies;
the plate body for each of the plurality of interchangeable faceplate assemblies being a plurality of plate bodies;
the plurality of plate bodies being serially positioned with the inner frame rim; and,
the plurality of plate bodies being coextensive with the inner frame rim.

7. The modular light switch and electric receptacle faceplate system as claimed in claim 6 comprising:
the inner frame rim comprising a first lengthwise section and a second lengthwise section;
the first lengthwise section and the second lengthwise section being positioned parallel and opposite to each other about the inner frame rim;
the first outer snap feature for each of the plurality of interchangeable faceplate assemblies being positioned along the first lengthwise portion; and,
the second outer snap feature for each of the plurality of interchangeable faceplate assemblies being positioned along the second lengthwise portion.

8. The modular light switch and electric receptacle faceplate system as claimed in claim 1 comprising:
the at least one interface opening being centrally positioned on the plate body.

9. The modular light switch and electric receptacle faceplate system as claimed in claim 1, wherein the at least one interface opening is configured to receive a toggle switch.

10. The modular light switch and electric receptacle faceplate system as claimed in claim 1, wherein the at least one interface opening is configured to receive a rocker switch.

11. The modular light switch and electric receptacle faceplate system as claimed in claim 1, wherein the at least one interface opening is configured to receive an outlet opening.

12. The modular light switch and electric receptacle faceplate system as claimed in claim 1 comprising:
at least one night-light; and,
the at least one night-light being integrated into the plate body.

13. A modular light switch and electric receptacle faceplate system comprising:
a surrounding frame;
at least one interchangeable faceplate assembly;
the surrounding frame comprising an inner frame rim, a first frame face, a second frame face, and an inner frame ledge;
the at least one interchangeable faceplate assembly comprising a plate body, at least one interface opening, a first inner snap feature, a first outer snap feature, a second inner snap feature, and a second outer snap feature;
the at least one interface opening traversing normal through the plate body;
the first inner snap feature being peripherally integrated into the plate body;
the second inner snap feature being peripherally integrated into the plate body, opposite to the first inner snap feature;
the first outer snap feature and the second outer snap feature being mounted onto the inner frame rim;
the first outer snap feature and the second outer snap feature being positioned opposite to each other about the inner frame rim;
the plate body being positioned within the inner frame rim;
the first inner snap feature and the first outer snap feature being engaged to each other;
the second inner snap feature and the second outer snap feature being engaged to each other;
the at least one interface opening being centrally positioned on the plate body;
the first frame face and the second frame face being positioned opposite to each other about the surrounding frame;
the inner frame ledge being connected onto the second frame face;
the inner frame ledge being positioned around the inner frame rim; and,
the first outer snap feature and the second outer snap feature being integrated into the inner frame rim.

14. The modular light switch and electric receptacle faceplate system as claimed in claim 13, wherein the first inner snap feature is a female piece of a snap-fit fastener, and wherein the first outer snap feature is a male piece of the snap-fit fastener.

15. The modular light switch and electric receptacle faceplate system as claimed in claim 13, wherein the second inner snap feature is a female piece of a snap-fit fastener, and wherein the second outer snap feature is a male piece of the snap-fit fastener.

16. The modular light switch and electric receptacle faceplate system as claimed in claim 13 comprising:
at least one night-light;
the at least one interchangeable faceplate assembly further comprising a plurality of fastener-receiving holes;
the plurality of fastener-receiving holes traversing normal through the plate body;
the plurality of fastener-receiving holes being distributed across the plate body;
the plurality of fastener-receiving holes being positioned about the plate opening; and,
the at least one night-light being integrated into the plate body.

17. The modular light switch and electric receptacle faceplate system as claimed in claim 13 comprising:
the inner frame rim comprising a first lengthwise section and a second lengthwise section;
the at least one interchangeable faceplate assembly being a plurality of interchangeable faceplate assemblies;
the plate body for each of the plurality of interchangeable faceplate assemblies being a plurality of plate bodies;
the plurality of plate bodies being serially positioned with the inner frame rim;
the plurality of plate bodies being coextensive with the inner frame rim;
the first lengthwise section and the second lengthwise section being positioned parallel and opposite to each other about the inner frame rim;
the first outer snap feature for each of the plurality of interchangeable faceplate assemblies being positioned along the first lengthwise portion; and,
the second outer snap feature for each of the plurality of interchangeable faceplate assemblies being positioned along the second lengthwise portion.

18. The modular light switch and electric receptacle faceplate system as claimed in claim 13, wherein the at least one interface opening is configured to receive a toggle switch.

19. The modular light switch and electric receptacle faceplate system as claimed in claim 13, wherein the at least one interface opening is configured to receive a rocker switch.

20. The modular light switch and electric receptacle faceplate system as claimed in claim 13, wherein the at least one interface opening is configured to receive an outlet opening.
